(19) United States
(12) Patent Application Publication
(10) Pub. No.: US 2022/0055238 A1
(43) Pub. Date: Feb. 24, 2022

(54) RAZOR HEAD

(71) Applicant: Jianzhong HUANG, Yuyao (CN)

(72) Inventor: Jianzhong HUANG, Yuyao (CN)

(21) Appl. No.: 17/519,761

(22) Filed: Nov. 5, 2021

Related U.S. Application Data
(63) Continuation of application No. PCT/CN2021/126300, filed on Oct. 26, 2021.

(30) Foreign Application Priority Data
Sep. 27, 2021 (CN) 202111132699.3

(51) Int. Cl. B26B 21/40

(52) U.S. Cl. CPC B26B 21/4018

(57) ABSTRACT

A razor head, including a razor head body and a protection cover. The protection cover includes a fixing part and a covering part. The fixing part is arranged between a fixed blade and a blade holder of the razor head body. A head end of the fixing part is provided with the covering part. The covering part is arranged outside the fixed blade and a movable blade. A head end of the covering part is provided with a plurality of through holes to allow the hair to pass through to enter a cutting area between the fixed blade and the movable blade.

### CROSS-REFERENCE TO RELATED APPLICATIONS

This application is a continuation of International Application No. PCT/CN2021/126300, filed on Oct. 26, 2021, which claims the benefit of priority from Chinese Patent Application No. 202111132699.3, filed on Sep. 27, 2021. The content of the aforementioned applications, including any intervening amendments thereto, are incorporated herein by reference.

### TECHNICAL FIELD

This application relates to articles for daily use, and more particularity to a razor head.

### BACKGROUND

Razor includes a hair clipper for haircutting and a shaver for shaving body hair, etc. The existing razor head includes a fixed blade and a movable blade installed on a blade holder, where the movable blade is pressed on the fixed blade by a spring, and the movable blade is driven by a swing frame to move left and right, thereby forming a shear with the fixed blade to cut hair entering the serration area. Unfortunately, the skin wrinkles under the armpits or baby skin may be cut during use. In addition, the spring may bounce or even break under pressure during use, causing the movable blade to shift to hurt the skin.

Therefore, there is an urgent need for those skilled in the art to develop a razor head with a protection device.

### SUMMARY

In order to overcome the above-described problems in the prior art, the present disclosure provides a razor head, on which a protection cover is provided to effectively prevent the razor blade from cutting the human skin.

Technical solutions of the disclosure are described as follows.

The present disclosure provides a razor head, comprising:

a razor head body; and

a protection cover;

wherein the protection cover comprises a fixing part and a covering part; the razor head body is provided with a fixed blade and a blade holder; the fixing part is arranged between the fixed blade and the blade holder; the covering part is provided at a head end of the fixing part; the covering part is arranged outside the fixed blade and a movable blade, and is configured to cover the fixed blade and the movable blade; a head end of the covering part is provided with a plurality of through holes; and the plurality of through holes are configured to allow hair of a subject to pass through to enter a cutting area between the fixed blade and the movable blade.

In some embodiments, the razor head body is provided with the blade holder, the fixed blade, a swing frame and the movable blade; the fixed blade is configured to fix the hair; the swing frame is configured to be connected to a swing head; the moveable blade is configured to cut the hair; the fixed blade is fixed on the blade holder; the movable blade is movably connected between the fixed blade and the swing frame; the movable blade is pressed on the fixed blade by a spring; the swing frame is movably connected to the blade holder; the swing frame is configured to provide a swing force to the movable blade; and the movable blade is configured to swing synchronously with the swing frame and swing left and right with respect to both sides of the fixed blade.

In some embodiments, the fixing part is provided with a positioning hole; and the positioning hole is matched with a positioning column on the blade holder.

In some embodiments, the covering part comprises a connecting plate and a bending part; the connecting plate is connected to the fixing part; the bending part is V-shaped and is formed by extending the connecting plate towards a head end of the bending part and bending upwards; the head end of the bending part is an arc transition section; the plurality of through holes are laterally distributed on the arc transition section; and each of the plurality of through holes is an elongated hole arranged along a contour of the arc transition section.

In some embodiments, the number of the plurality of through holes is not less than the number of the cutting area.

In some embodiments, a width of the covering part is greater than a width of the fixed blade.

In some embodiments, the protection cover is an injection molded part made of a plastic.

Compared to the prior art, the present disclosure has the following beneficial effects.

In the razor head provided herein, a protection cover is provided outside the fixed blade and the movable blade to allow the hair to enter the cutting area therethrough, which can effectively protect the skin from being hurt by the blade. Moreover, the protection cover is fixed on the blade holder and is integrated with the entire razor head, so that the razor head of the disclosure has simple operation, and the protection cover is not easy to get lost.

### BRIEF DESCRIPTION OF THE DRAWINGS

Technical solutions of the present disclosure and the prior art will be described below with reference to the accompany drawings to facilitate the understanding. Obviously, presented in the accompany drawings are merely some embodiments of the present disclosure, and other drawings can be obtained by those skilled in the art based on the drawings provided herein without paying creative effort.

FIG. 1 is a perspective view of a razor head according to an embodiment of the present disclosure; and

FIG. 2 is a perspective view of a protection cover according to an embodiment of the present disclosure.

In the drawings, 1, blade holder; 2, fixed blade; 3, movable blade; 4, swing frame; 5, protection cover; 6, spring; 7, fixing part; 71, positioning hole; 8, covering part; 81, connecting plate; 82, bending part; and 9, through hole.

### DETAILED DESCRIPTION OF EMBODIMENTS

Technical solutions of the present disclosure will be clearly and completely described below with reference to the embodiments and accompanying drawings. Obviously, described below are merely some embodiments of this disclosure, and are not intended to limit the disclosure. Other embodiments made by those skilled in the art based on the embodiments provided herein without paying any creative effort should fall within the scope of the present disclosure.

An object of the present disclosure is to provide a razor head to overcome the problems in prior art.

In order to make the objectives, features and advantages of the disclosure clear, the disclosure will be described in detail below with reference to the accompanying drawings and embodiments.

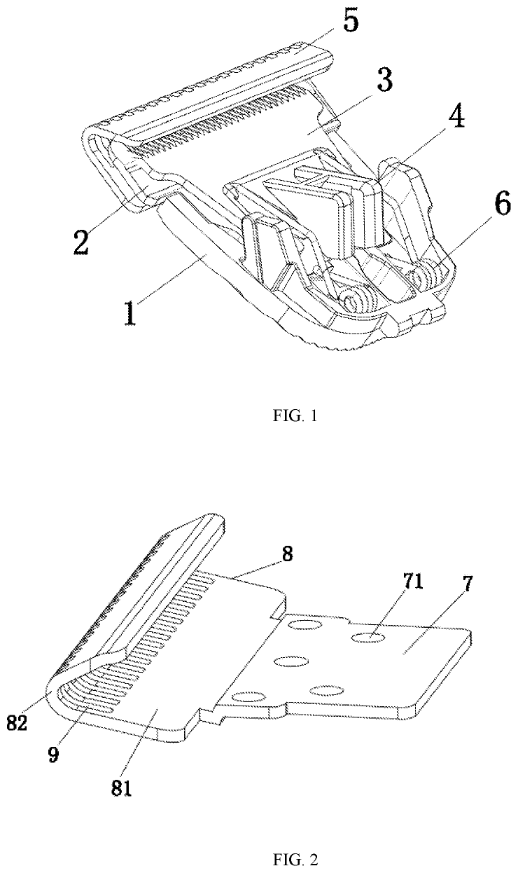

As shown in FIG. 1, a razor head of the present disclosure includes a razor head body and a protection cover 5. The razor head body includes a blade holder 1, a fixed blade 2 configured to fix hair, a swing frame 4 configured to be connected to a swing head and a movable blade 3 configured to cut the hair. The fixed blade 2 is fixed on the blade holder 1. The movable blade 3 is movably connected between the fixed blade 2 and the swing frame 4. The movable blade 3 is pressed on the fixed blade 2 by a spring 6. The swing frame 4 is movably connected to the blade holder 1. The swing frame 4 is configured to provide swing force to the movable blade 3. The movable blade 3 is capable of swinging with the swing frame 4 synchronously and swinging left and right with respect to both sides of the fixed blade 2.

The protection cover 5 includes a fixing part 7 and a covering part 8. The fixing part 7 is arranged between the fixed blade 2 and the blade holder 1. A head end of the fixing part 7 is provided with the covering part 8. The covering part 8 is arranged outside the fixed blade 2 and the movable blade 3, and is configured to cover the fixed blade 2 and the movable blade 3. A head end of the covering part 7 is provided with a plurality of through holes 9 to allow the hair to pass through to enter a cutting area between the fixed blade 2 and the movable blade 3 through the through holes 9.

As shown in FIG. 2, the fixing part 7 is provided with a positioning hole 71 matched with a positioning column arranged on the blade holder 1.

The covering part 8 includes a connecting plate 81 and a bending part 82. The connecting plate 81 is connected to the fixing part 7. The bending part 82 is V-shaped and is formed by extending the connecting plate 81 toward a head end of the bending part 82 and bending upwards. The head end of the bending part 82 is a smooth arc transition section. The through holes 9 are laterally distributed on the arc transition section. Each of the through holes 9 is an elongated hole arranged along a contour of the arc transition section. The number of the through holes 9 is not less than the number of the cutting area. A width of the covering part 8 is greater than a width of the fixed blade 2.

In the razor head provided herein, the protection cover 5 is provided to allow the hair to enter the cutting area therethrough, such that the skin is protected from being cut by blade.

The embodiments mentioned above are merely used to help understand the principle and concept of the present disclosure, and should not be considered to limit the disclosure. It should be understood that any changes, replacements and modifications made by those skilled in the art without departing from the spirit of the present disclosure should fall within the scope of the disclosure defined by the appended claims.

What is claimed is:

1. A razor head, comprising:
a razor head body; and
a protection cover;
wherein the protection cover comprises a fixing part and a covering part; the razor head body is provided with a fixed blade and a blade holder; the fixing part is arranged between the fixed blade and the blade holder; the covering part is provided at a head end of the fixing part; the covering part is arranged outside the fixed blade and a movable blade, and is configured to cover the fixed blade and the movable blade; a head end of the covering part is provided with a plurality of through holes;
and the plurality of through holes are configured to allow hair of a subject to pass through to enter a cutting area between the fixed blade and the movable blade.

2. The razor head of claim 1, wherein the razor head body is provided with the blade holder, the fixed blade, a swing frame and the movable blade; the fixed blade is configured to fix the hair; the swing frame is configured to be connected to a swing head; the moveable blade is configured to cut the hair; the fixed blade is fixed on the blade holder; the movable blade is movably connected between the fixed blade and the swing frame; the movable blade is pressed on the fixed blade by a spring; the swing frame is movably connected to the blade holder; the swing frame is configured to provide a swing force to the movable blade; and the movable blade is configured to swing with the swing frame synchronously and swing left and right with respect to both sides of the fixed blade.

3. The razor head of claim 2, wherein the fixing part is provided with a positioning hole; and the positioning hole is matched with a positioning column on the blade holder.

4. The razor head of claim 3, wherein the covering part comprises a connecting plate and a bending part; the connecting plate is connected to the fixing part; the bending part is V-shaped and is formed by extending the connecting plate towards a head end of the bending part and bending upwards; the head end of the bending part is an arc transition section; the plurality of through holes are laterally distributed on the arc transition section; and each of the plurality of through holes is an elongated hole arranged along a contour of the arc transition section.

5. The razor head of claim 4, wherein the number of the plurality of through holes is not less than the number of the cutting area.

6. The razor head of claim 1, wherein a width of the covering part is greater than a width of the fixed blade.

7. The razor head of claim 1, wherein the protection cover is an injection molded part made of a plastic.
